(19) United States
(12) Patent Application Publication
(10) Pub. No.: US 2026/0313241 A1
(43) Pub. Date: Oct. 8, 2026

(54) IMAGE CAPTURING APPARATUS CAPABLE OF CAPTURING IMAGE WITH REDUCED FLICKER, CONTROL METHOD THEREFOR, AND STORAGE MEDIUM

(71) Applicant: CANON KABUSHIKI KAISHA, Tokyo (JP)

(72) Inventor: TAKUYA MASAMURA, Tokyo (JP)

(21) Appl. No.: 19/575,708

(22) Filed: Mar. 23, 2026

(30) Foreign Application Priority Data
Apr. 7, 2025 (JP) 2025-062991

(51) Int. Cl. H04N 23/745; H04N 7/01

(52) U.S. Cl. CPC H04N 23/745; H04N 7/0132

(57) ABSTRACT

An apparatus includes a sensor, a controller, and a detector that detects flicker from sensor signals. The controller switches among flicker-detection drive methods: a first method using multiple frame rates and a second method using fewer frame-rate types than the first. Before capturing a first still image in continuous shooting, the controller drives the sensor by the first method to obtain signals for a first detection. Between capturing the first and second still images, the controller drives the sensor by the second method for a second detection. If the flicker detected first is also detected second, the apparatus captures the second still image. Otherwise, the controller drives the sensor by a third method different from the second method, performs a third detection, and then captures the second still image.

### BACKGROUND

### Field of the Technology

The aspect of the embodiments relates to an image capturing apparatus capable of capturing an image with reduced flicker, a control method therefor, and a storage medium.

### Description of the Related Art

Fluorescent lamps, which are widely used as indoor light sources, cause periodic fluctuations in light intensity (flicker) due to the influence of commercial power supply frequency. If images are captured at a high shutter speed under a light source that causes such flicker (hereinbelow, referred to as a flicker light source), uneven exposure or color may occur within an image, or variations in exposure and color temperature may occur between a plurality of images captured in succession.

In recent years, light sources using light-emitting diodes (hereinbelow referred to as LEDs) have become increasingly common. Many light sources using LEDs flicker at a quicker cycle than fluorescent lamps (hereinbelow, referred to as high-frequency flicker light sources).

A method for setting a shutter speed to match a flickering cycle of a high-frequency flicker light source is known as a measure to suppress the effect of high-frequency flicker. However, it is troublesome for a user to manually set the shutter speed to match the flickering cycle of the high-frequency flicker light source. Thus, Japanese Patent Laid-Open No. 2022-130277 describes a method for automatically detecting a frequency of flicker occurring in a subject and reducing its impact on an image. However, the frequency of the high-frequency flicker light source changes depending on color of the light source or the like, and the flicker frequency may change during imaging. Particularly, in a case where the flicker frequency changes during continuous imaging, it may be difficult to achieve both a reduction in the effect of flicker and a high continuous imaging speed.

### SUMMARY

According to an aspect of the embodiments, an apparatus includes a sensor configured to capture an image of a subject, and at least one memory coupled to at least one processor storing instructions that, when executed by the at least one processor, cause the at least one processor to function as a control unit configured to control drive of the sensor, and a detection unit configured to detect flicker, which is a periodic change in light intensity, based on a signal output from the sensor, wherein the control unit controls the sensor using a first method for acquiring a signal of flicker detection by capturing an image using a plurality of frame rates and a second method for acquiring a signal of flicker detection by capturing an image using frame rates fewer than those of the first method, wherein the control unit drives the sensor by the first method before capturing a first still image for recording in continuous imaging, and the detection unit performs first detection based on the acquired signal, wherein the control unit drives the sensor by the second method between capturing the first still image for recording and capturing a second still image for recording in the continuous imaging, and the detection unit performs second detection based on the acquired signal, wherein, in a case where first flicker detected in the first detection is detected in the second detection, capturing the second still image for recording is executed, and wherein, in a case where the first flicker is not detected in the second detection, the control unit drives the sensor using a method different from the second method after the second detection, the detection unit performs third detection based on the acquired signal, and then capturing the second still image for recording is executed.

Features of the disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of a camera body and a lens unit according to an embodiment of an image capturing apparatus to which the disclosure is applied.

FIG. 2 is a flowchart illustrating high-frequency flicker-free imaging according to a first embodiment of the disclosure.

FIG. 3 is an imaging sequence illustrating high-frequency flicker-free imaging according to the first embodiment of the disclosure.

FIG. 4 is a flowchart illustrating high-frequency flicker-free imaging according to a second embodiment of the disclosure.

FIG. 5 is an imaging sequence illustrating high-frequency flicker-free imaging according to a third embodiment of the disclosure.

### DESCRIPTION OF THE EMBODIMENTS

Embodiments of the disclosure will be described in detail below with reference to the attached drawings. It is noted that the following embodiments are not meant to limit the scope of the disclosure as encompassed by the appended claims. A plurality of features is described in the embodiments, but not all of these features are essential to the disclosure, and the plurality of features may be arbitrarily combined. Further, the same or similar components in the attached drawings are denoted by the same reference numerals, and redundant description will be omitted.

### First Embodiment

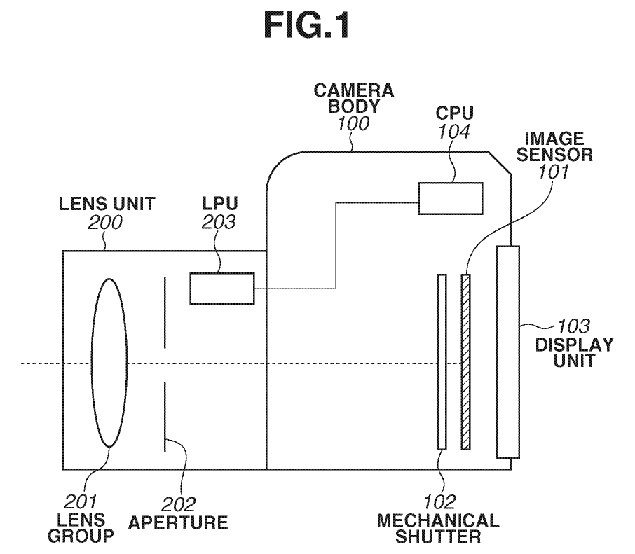

FIG. 1 is a block diagram illustrating a configuration of a camera body 100 and a lens unit 200 according to an embodiment of an image capturing apparatus to which the disclosure is applied. One or more functional blocks illustrated in FIG. 1 may be implemented in hardware such as an application specific integrated circuit (ASIC) or a programmable logic array (PLA). The functional blocks may also be implemented by a programmable processor (microprocessor or microcomputer) such as a central processing unit (CPU) or a micro processing unit (MPU) executing software. Further, the functional blocks may be implemented by a combination of software and hardware. Accordingly, even if different functional blocks are described as main bodies of operations in the following description, they may be implemented by the same hardware as the main body.

First, each unit included in the camera body 100 is described. The camera body 100 includes a frame memory (not illustrated) that functions as a storage unit capable of temporarily storing a signal (video signal) and reading it out as necessary. Generally, the frame memory is also referred to as a random access memory (RAM), and in recent years, dual data rate 3 - synchronous dynamic RAM (DDR3-SDRAM) and the like are often used. Various types of processing can be performed using the frame memory.

An image sensor 101 is an image capturing unit that uses a charge storage type solid state image sensor, such as a complementary metal oxide semiconductor (CMOS) or a charge coupled device (CCD), which can receive a light beam of a subject guided into the inside of the camera body 100 via the lens unit 200 and convert it into an electrical image signal. The image sensor 101 may include an infrared cut filter, a low-pass filter, and the like. An image (signal) acquired using the image sensor 101 under drive control by a CPU 104, which is described below, is handled as various image signals, such as for live view display, detection of flicker, which is a periodic change in light intensity, and a captured image for recording. Since the electrical signal acquired by the image sensor 101 has an analog value, the image sensor 101 also has a function of converting the analog value into a digital value. It is possible to detect an evaluation value (photometric value) related to brightness of the subject based on the image signal output from the image sensor 101. Further, it is possible to control an exposure time of the image sensor 101 according to a shutter speed that can be set as an exposure control value for the image sensor 101.

A mechanical shutter 102 is a light blocking member that can move in a direction parallel to a signal scanning direction of the image sensor 101. The exposure time of the image sensor 101 can be controlled by adjusting an exposure aperture formed by a plurality of shutter blades included in the mechanical shutter 102 in accordance with the above-described shutter speed. The adjustment of the exposure time according to the disclosure can be realized using one or both an electronic shutter and the mechanical shutter 102 by adjusting timing of resetting and reading out signals of the image sensor 101.

A display unit 103 is a display device that can be visually confirmed by a user, and enables the user to check an operation status of the camera body 100. For example, the display unit 103 displays a video subjected to image processing based on the image signal of the subject and a setting menu. However, a liquid crystal display (LCD) or an organic electroluminescence (EL) may be used as the display unit 103. Live view display can be performed by displaying an image captured by the image sensor 101 and setting conditions, such as an exposure control value, on the display unit 103 in real time while imaging the subject. The display unit 103 according to the embodiment includes a resistive or capacitive thin film element referred to as a touch panel, and also functions as an operation unit that enables a user to perform a touch operation. In other words, by touching a predetermined icon displayed in advance, the user can cause a function linked to the icon to operate, and the icon can also be used as an operation member.

The display unit 103 can display the image acquired by the image sensor 101 and various types of imaging setting information in real time during framing to realize a live view (LV), and also display an image captured in response to a user operation.

The CPU 104 is a control unit capable of comprehensively controlling each unit in the camera body 100. The CPU 104 is connected to a read-only memory (ROM) or a random access memory (RAM). The ROM (not illustrated) is a nonvolatile storage element that stores a program, various adjustment parameters, and the like for operating the CPU 104. The program read out from the ROM is loaded into a volatile RAM (not illustrated) and executed. Generally, a RAM uses an element that is slower and has a lower capacity than a frame memory (not illustrated).

Next, the lens unit 200 is described in detail. The lens unit 200 is an accessory that can be attached to and detached from the camera body 100 and is an interchangeable lens that includes a lens group 201, such as a focusing lens, a zoom lens, and a shift lens. For example, the focusing lens included in the lens group 201 can adjust the focus on the subject by adjusting a lens position in an optical axis direction of the lens.

An aperture 202 is a light intensity adjusting member that adjusts light intensity related to a light beam of the subject guided into the inside of the camera body 100 via the lens unit 200. According to the embodiment, the light intensity can be adjusted by adjusting an aperture diameter of the aperture 202, and it can be realized by changing an aperture value as an exposure control value related to the aperture diameter of the aperture 202.

A lens processing unit (LPU) 203 is a control unit that controls each unit in the lens unit 200 and can control, for example, driving of the lens group 201 and the aperture 202. The LPU 203 is connected to the CPU 104 of the camera body 100 via a terminal group (not illustrated), and is capable of driving each unit in the lens unit 200 in response to a control instruction from the CPU 104. The LPU 203 is also capable of communicating with the CPU 104 on the camera body side to exchange information about focus position, aperture, image stabilization control, and the like with the camera body 100.

Each unit of the image capturing apparatus and the like according to the first embodiment of the disclosure is described above, but the disclosure is not limited to the above-described configuration. For example, the camera body 100 may be configured to incorporate each device equivalent to the lens unit 200. Further, the image capturing apparatus is not limited to a digital camera, and may be an electronic device having an image capturing function, such as a smartphone, which is a type of a mobile phone, or a tablet terminal.

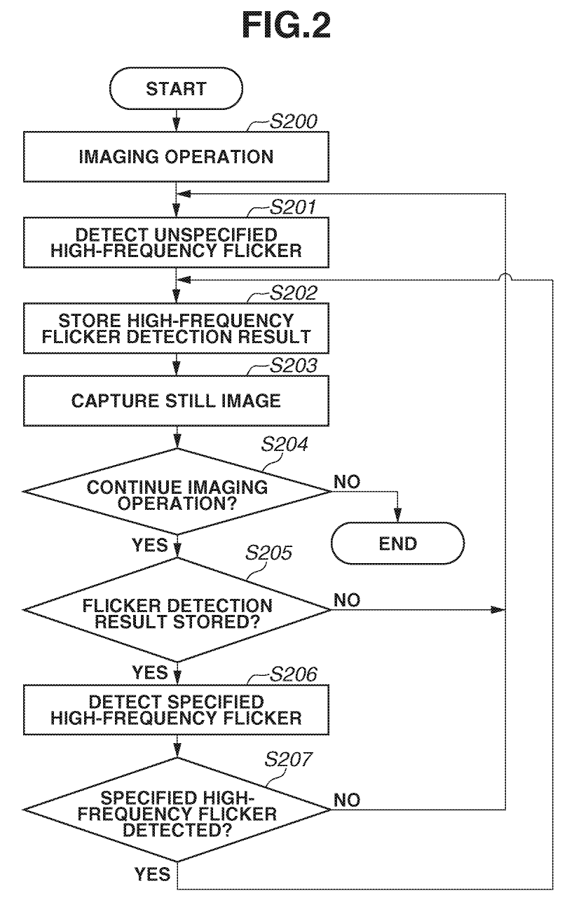

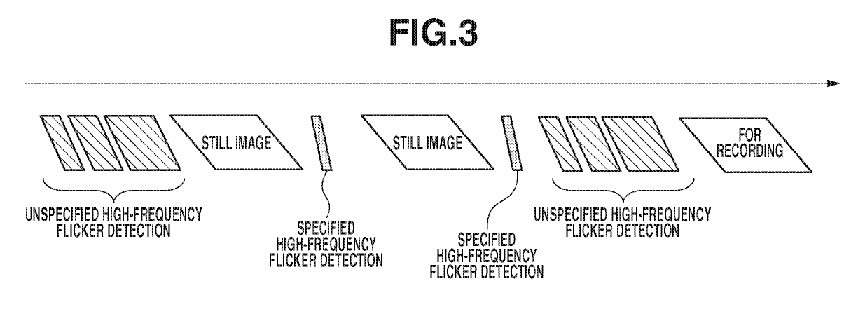

Next, processing continuous imaging according to the first embodiment is described with reference to FIGS. 2 and 3. According to the first embodiment, a part of flicker detection processing is omitted depending on a flicker detection state between continuous imaging, thereby achieving both a reduction in the effect of flicker and a high continuous imaging speed.

The processing illustrated in FIG. 2 is realized by the CPU 104 loading and executing a program stored in the ROM (not illustrated) and controlling each component of the camera body 100. Further, the processing illustrated in FIG. 2 is started in response to a user operation via a graphical user interface (GUI), such as a menu screen displayed on the display unit 103, or an operation unit (not illustrated). The same applies to FIG. 3, which is described below.

A flow in FIG. 2 illustrates processing in a case of performing continuous imaging while reducing the effect of high-frequency flicker (hereinbelow, referred to as high-frequency flicker-free imaging). In the flow in FIG. 2, it is assumed that the camera body 100 is set to reduce the effect of high-frequency flicker (mode setting) and set to perform continuous imaging (mode setting). It is assumed that the mode setting can be performed via, for example, a GUI such as a menu screen displayed on the display unit 103, or an operation unit (a mode setting button, a dial, or the like) not illustrated. The camera body 100 may be designed to perform operations described below during continuous imaging, regardless of the settings.

A method for identifying the flicker frequency in imaging is described as using, for example, the flicker detection processing described in Japanese Patent Laid-Open No. 2022-130277. Specific descriptions of the method for identifying the frequency are omitted. According to the embodiment, an imaging cycle (also referred to as a frame rate, hereinbelow, referred to as "flicker detection imaging cycle") for acquiring an image for flicker detection is set to three types: 159 fps, 200 fps, and 252 fps. Identifying the flicker frequency using these flicker detection imaging cycles is referred to as unspecified flicker detection. In implementing the disclosure, it is not necessary that the plurality of flicker detection imaging cycles are 159 fps, 200 fps, or 252 fps. As described in Japanese Patent Laid-Open No. 2022-130277, images may be captured using n imaging cycles (frame rates) (n is a natural number of three or more). However, as described in Japanese Patent Laid-Open No. 2022-130277, it is desirable that the plurality of flicker detection imaging cycles is not at least the least common multiple of each other.

The flicker detection that detects whether the flicker detected by the above-described unspecified flicker detection (hereinbelow referred to as "specified flicker") is present is referred to as "specified flicker detection". Here, the imaging cycle used for the specified flicker detection does not have to match the imaging cycle used for the unspecified flicker detection. In flicker detection processing, the CPU 104 changes the imaging cycle of the image sensor 101 to the flicker detection imaging cycle and acquires a predetermined number of images for each flicker detection drive.

First, in step S200, the CPU 104 checks whether an imaging operation is performed by a user. In a case where the imaging operation is performed, the processing proceeds to step S201. The imaging operation may correspond to, for example, an operation performed on an operating member (not illustrated) (such as a shutter button that receives an imaging instruction) or an operation performed on a GUI displayed on the display unit 103.

In step S201, the CPU 104 performs unspecified flicker detection processing for capturing a still image for recording during continuous imaging. The unspecified flicker detection processing is performed using the flicker detection processing described in Japanese Patent Laid-Open No. 2022-130277. In other words, the detection processing is performed using three or more types of flicker detection imaging cycles as described above. If the unspecified flicker detection processing is completed and the flicker is detected, the processing proceeds to step S202. In a case where the flicker is not detected, the processing proceeds to step S203.

In step S202, the flicker frequency detected in step S201 is stored in the RAM included in the CPU 104, and the processing proceeds to step S203. In a case where the flicker is not detected in step S201 described above, in step S202, information indicating that the flicker is not detected (non-detection information) may be generated, and, in step S203, the non-detection information may be stored in the RAM included in the CPU 104.

In step S203, the CPU 104 changes imaging control values (exposure settings) for capturing a still image for recording. The imaging control values include a shutter speed, an aperture value, International Organization for Standardization (ISO) sensitivity, and the like.

The imaging control values are changed to values that can minimize flicker based on the flicker frequency stored in step S202 and the imaging settings of the user. However, if the CPU 104 determines that there is no flicker, it does not change the imaging control values. For example, if the frequency of the specified flicker is 540.0 Hz, the CPU 104 sets the shutter speed to 1/540.0, changes the aperture value and ISO sensitivity to match the shutter speed, thereby changing the imaging control values (imaging settings) so that the still image is captured with the proper exposure. Further, the CPU 104 captures a first still image based on the determined imaging control values.

In step S204, the CPU 104 checks whether the user continues the imaging operation. If the imaging operation is continued (YES in step S204), the processing proceeds to step S205. If the imaging operation is not continued (NO in step S204), the imaging is terminated.

In step S205, the CPU 104 checks the flicker frequency stored in the RAM in step S202. If the flicker frequency is stored (YES in step S205), the processing proceeds to step S206. If it is determined that the flicker frequency is not stored (or that "non-detection information" is stored) (NO in step S205), the processing proceeds to step S201, where the CPU 104 performs the unspecified flicker detection and then captures a next still image for recording.

In step S206, the CPU 104 performs the specified flicker detection to check whether the flicker frequency stored in step S202 exists. The specified flicker detection is performed using the flicker detection processing described in Japanese Patent Laid-Open No. 2022-130277, but whether a specific flicker is present can be detected using fewer types of imaging cycles than those in the unspecified flicker detection. Thus, in the specified flicker detection, flicker detection processing is performed using fewer types of imaging cycles than those in the unspecified flicker detection. Here, since the specified flicker detection uses fewer types of imaging cycles than those in the unspecified flicker detection, a time required for detection is shorter than that in the unspecified flicker detection.

In step S207, the CPU 104 determines whether the specified flicker can be detected in step S206. If the specified flicker can be detected (YES in step S207), the processing proceeds to step S202, and the detected flicker frequency is stored in the RAM included in the CPU 104. Then, in step S203, the CPU 104 captures the next still image. In this case, the CPU 104 can perform the specified flicker detection using fewer types of imaging cycles than those in the unspecified flicker detection, and can then capture the next still image. Thus, the frame rate can be improved compared with a case where the unspecified flicker detection is performed between every frame, as in a second still image illustrated in FIG. 3.

In a case where the specified flicker cannot be detected (NO in step S207), the processing proceeds to step S201, where the CPU 104 performs the unspecified flicker detection as in a third still image illustrated in FIG. 3 and then captures the next sill image. In this case, a new flicker frequency is specified through the unspecified flicker detection, and thus it is possible to capture an image with reduced flicker even if the flicker frequency changes.

As described above, according to the flowchart illustrated in FIG. 2, by performing the specified flicker detection before the unspecified flicker detection, it is possible to capture an image with reduced flicker while maintaining a high frame rate as long as the flicker frequency does not change. Further, even if the flicker frequency changes, it is possible to capture an image with reduced flicker. In other words, it is possible to achieve both a reduction in the effect of flicker and a high continuous imaging speed.

### Second Embodiment

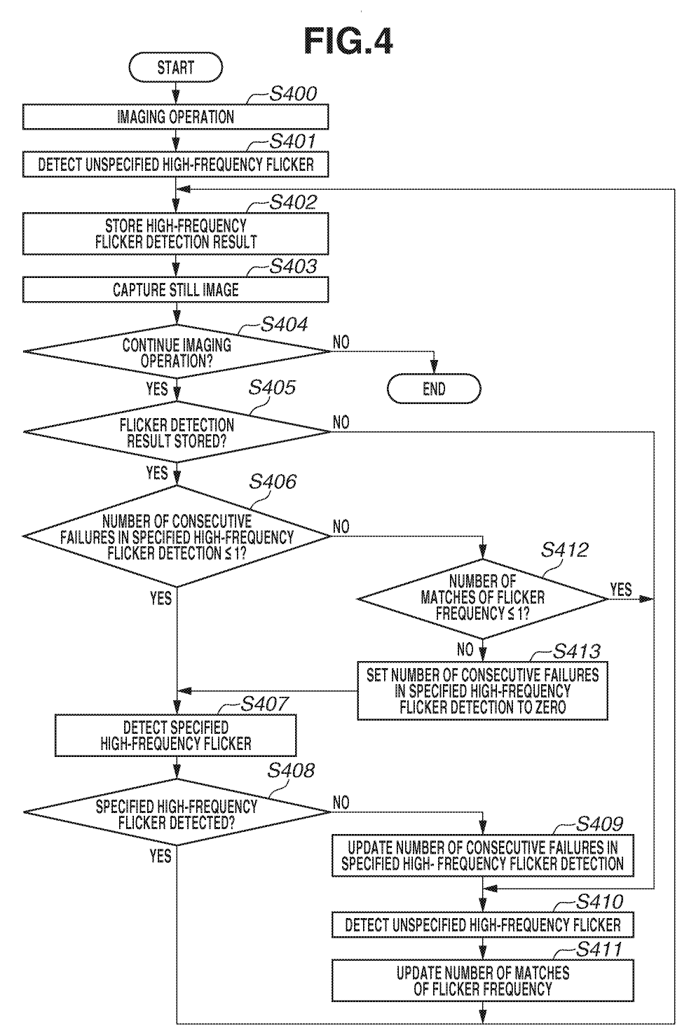

Next, processing in continuous imaging according to a second embodiment is described with reference to FIG. 4. The second embodiment is a modification of the first embodiment that addresses a case where the flicker frequency changes during continuous imaging. Particularly, the second embodiment is mainly characterized in that processing is added, to the first embodiment, in which the number of consecutive failures in the specified flicker detection and the number of matches of the flicker frequency detected in the unspecified flicker detection are stored in the RAM included in the CPU 104. The processing in FIG. 4 is also realized by the CPU 104 loading and executing a program stored in the ROM (not illustrated) and controlling each component of the camera body 100.

First, processing in steps S400 to S405 is similar to that in steps S200 to S205, and thus a description thereof is omitted. The CPU 104 checks the flicker frequency stored in the RAM in step S402. If the flicker frequency is stored (YES in step S405), the processing proceeds to step S406. If it is determined that the flicker frequency is not stored (or that "non-detection information" is stored) (NO in step S405), the processing proceeds to step S401, where the CPU 104 performs the unspecified flicker detection and then captures a next still image for recording.

Subsequently, in step S406, the CPU 104 determines whether the number of consecutive failures in the specified flicker detection is one or less. If the processing in step S406 is performed for the first time, the number of consecutive failures is zero (YES in step S406), and the processing proceeds to step S407. In a case where the number of consecutive failures in the specified flicker detection is not one or less (NO in step S406), the processing proceeds to step S412.

In step S407, as in step S206, the CPU 104 executes the specified flicker detection, and the processing proceeds to step S408.

In step S408, as in step S207, the CPU 104 determines whether the specified flicker can be detected. If the specified flicker can be detected (YES in step S408), the processing proceeds to step S402 in the same manner as if it is determined YES in step S207 (in FIG. 2, the processing proceeds to step S202). In step S408, if the specified flicker cannot be detected (NO in step S408), the processing proceeds to step S409.

In step S409, the CPU 104 increments the number of consecutive failures in the specified flicker detection to a value of one, and the processing proceeds to step S410. The number of consecutive failures is stored in the RAM at the time of increment.

In step S410, as in step S401, the CPU 104 performs the unspecified flicker detection, and the processing proceeds to step S411.

In step S411, the CPU 104 compares the flicker frequency detected in the unspecified flicker detection in step S401 with the flicker frequency detected in the unspecified flicker detection in step S410. If the flicker frequencies detected in step S401 and step S410 matches, the CPU 104 increments the number of matches of the flicker frequency. If they do not match, the CPU 104 sets the number of matches of the flicker frequency to zero. The number of matches of the flicker frequency is also stored in the RAM. After completing the processing, the processing proceeds to step S402.

In the above-described flow, in step S406, if the number of consecutive failures in the specified flicker detection reaches two (NO in step S406), the processing proceeds to step S412.

In step S412, the CPU 104 determines whether the number of matches of the flicker frequency updated in step S411 is one or less. The determination may be made by referring to the latest number of matches of the flicker frequency stored in the RAM. If the number of matches of the flicker frequency is one or less (YES in step S412), the processing proceeds to step S410. Otherwise (NO in step S412), the processing proceeds to step S413.

As a result of the above-described processing, if the specified flicker cannot be detected twice in succession, the CPU 104 does not detect the specified flicker but instead detects the unspecified flicker, and proceeds to capture the next still image. Accordingly, even if the frequency of the occurring flicker changes from frame to frame, it is possible to capture an image with reduced flicker without reducing the frame rate.

Further, a case where the flicker frequency no longer changes from frame to frame from this state is described with reference to the flowchart illustrated in FIG. 4. First, in step S410, as in step S401, the CPU 104 executes the unspecified flicker detection, and the processing proceeds to step S411. Information about the detected flicker is stored in the RAM as the latest detection result at this time point.

In step S411, the CPU 104 compares the flicker frequency detected in the unspecified flicker detection in previous step S410 with that detected in current step S410. If the flicker frequencies matches, the CPU 104 increments the number of matches of the flicker frequency. If they do not match, the CPU 104 sets the number of matches of the flicker frequency to zero. The number of matches of the flicker frequency is also stored in the RAM. After completing the processing, the processing proceeds to step S402.

In the above-described flow, in step S412, if the number of matches of the flicker frequency in the unspecified flicker detection reaches two (NO in step S412), the processing proceeds to step S413.

In step S413, the CPU 104 sets the number of consecutive failures in the specified flicker detection to zero, proceeds to step S407, and returns to a state where the specified flicker detection is performed.

As a result of the above-described processing, if the flicker frequencies resulting from the unspecified flicker detection match twice in succession, the CPU 104 performs the specified flicker detection and then proceeds to capture the next still image. Accordingly, as long as the flicker frequency does not change, it is possible to capture an image with reduced flicker while maintaining a high frame rate.

As described above, according to the flowchart illustrated in FIG. 4, even if the flicker frequency changes, it is possible to capture an image with reduced flicker while maintaining a high frame rate.

### Third Embodiment

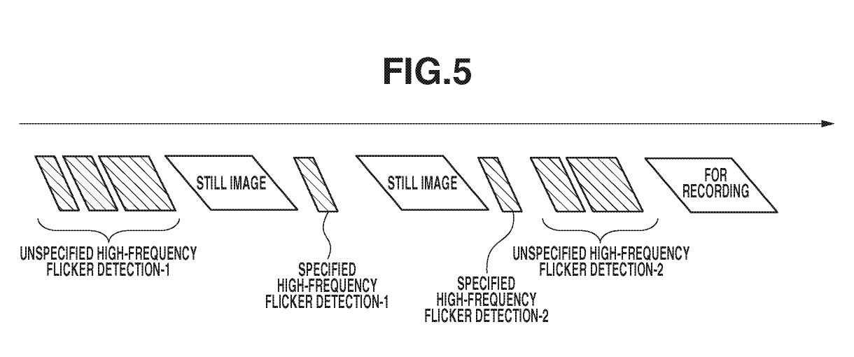

Next, an imaging sequence in a case where any of flicker detection imaging cycles for the specified flicker detection and for the unspecified flicker detection match according to a third embodiment is described with reference to FIG. 5. The imaging sequence according to the third embodiment is described based on differences from the imaging sequence illustrated in FIG. 3.

In FIG. 5, first, unspecified flicker detection A for capturing a first still image for recording is performed at flicker detection imaging cycles 159 fps, 200 fps, and 252 fps. In other words, it is similar to processing for the unspecified flicker detection for the first still image for recording illustrated in FIG. 3.

Subsequently, specified flicker detection A is performed for capturing a second still image for recording.

Here, it is assumed that the specified flicker detection A is performed at the flicker detection imaging cycle of 159 fps, which is included in the unspecified flicker detection A. If the specified flicker detection A can be completed, specified flicker detection B is further performed at the flicker detection imaging cycle of 159 fps for capturing a third still image for recording.

Here, it is assumed that the specified flicker cannot be detected by the specified flicker detection B.

In this case, according to the first embodiment, the unspecified flicker detection A (detection at the flicker detection imaging cycles of 159 fps, 200 fps, and 252 fps) is performed. On the other hand, according to the third embodiment, detection at the flicker detection imaging cycle of 159 fps is already performed by the specified flicker detection B. Thus, instead of performing the unspecified flicker detection A, in one embodiment, unspecified flicker detection B can be performed at only the flicker detection imaging cycles of 200 fps and 252 fps, and the unspecified flicker detection can be performed in conjunction with the results of the specified flicker detection B. According to the above-described processing, it is possible to reduce a detection time for the unspecified flicker detection. In other words, it is possible to achieve both a reduction in the effect of flicker and a high continuous imaging speed.

### Other Embodiment

The disclosure can also be realized by processing of supplying a program for implementing one or more functions of the above-described embodiments to a system or an apparatus via a network or a storage medium and having one or more processors in a computer of the system or the apparatus read and execute the program. The disclosure can also be realized by a circuit (e.g., ASIC) that realizes one or more functions.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-062991, filed April 7, 2025, which is hereby incorporated by reference herein in its entirety.

What is claimed is:

1. An apparatus comprising:
a sensor configured to capture an image of a subject; and
at least one memory coupled to at least one processor storing instructions that, when executed by the at least one processor, cause the at least one processor to function as:
a control unit configured to control drive of the sensor; and
a detection unit configured to detect flicker, which is a periodic change in light intensity, based on a signal output from the sensor,
wherein the control unit controls the sensor using a first method for acquiring a signal of flicker detection by capturing an image using a plurality of frame rates and a second method for acquiring a signal of flicker detection by capturing an image using frame rates fewer than those of the first method,
wherein the control unit drives the sensor by the first method before capturing a first still image for recording in continuous imaging, and the detection unit performs first detection based on the acquired signal,
wherein the control unit drives the sensor by the second method between capturing the first still image for recording and capturing a second still image for recording in the continuous imaging, and the detection unit performs second detection based on the acquired signal,
wherein, in a case where first flicker detected in the first detection is detected in the second detection, capturing the second still image for recording is executed, and
wherein, in a case where the first flicker is not detected in the second detection, the control unit drives the sensor using a method different from the second method after the second detection, the detection unit performs third detection based on the acquired signal, and then capturing the second still image for recording is executed.

2. The apparatus according to claim 1, wherein the first method controls the sensor at n different frame rates, n being a natural number of three or more, and the least common multiple of the n frame rates does not include any of the n frame rates.

3. The apparatus according to claim 2, wherein the second method drives the sensor at one frame rate at which the first flicker can be detected.

4. The apparatus according to claim 3, wherein the second method drives the sensor at a first frame rate, which is one of the n different frame rates.

5. The apparatus according to claim 4, wherein a method for the sensor used in the third detection drives the sensor at frame rates excluding the first frame rate from the n different frame rates.

6. A method executed by an apparatus comprising:
controlling drive of a sensor;
detecting flicker, which is a periodic change in light intensity, based on a signal output from the sensor;
controlling the sensor using a first method for acquiring a signal of flicker detection by capturing an image using a plurality of frame rates and a second method for acquiring a signal of flicker detection by capturing an image using frame rates fewer than those of the first method;
driving the sensor by the first method before capturing a first still image for recording in continuous imaging, and performing first detection in the detecting the flicker based on the acquired signal;
driving the sensor by the second method in the controlling between capturing the first still image for recording and capturing a second still image for recording in the continuous imaging, and performing second detection in the detecting the flicker based on the acquired signal;
in a case where first flicker detected in the first detection is detected in the second detection, executing capturing of the second still image for recording; and
in a case where the first flicker is not detected in the second detection, driving the sensor in the controlling using a method different from the second method after the second detection, performing third detection in the detecting the flicker based on the acquired signal, and then executing capturing of the second still image for recording.

7. The method according to claim 6, wherein the first method controls the sensor at n different frame rates, n being a natural number of three or more, and the least common multiple of the n frame rates does not include any of the n frame rates.

8. The method according to claim 7, wherein the second method drives the sensor at one frame rate at which the first flicker can be detected.

9. The method according to claim 8, wherein the second method drives the sensor at a first frame rate, which is one of the n different frame rates.

10. The method according to claim 9, wherein a method for the sensor used in the third detection drives the sensor at frame rates excluding the first frame rate from the n different frame rates.

11. A non-transitory computer-readable storage medium storing a program for causing a computer to perform a method, the method comprising:
controlling drive of a sensor;
detecting flicker, which is a periodic change in light intensity, based on a signal output from the sensor;
controlling the sensor using a first method for acquiring a signal of flicker detection by capturing an image using a plurality of frame rates and a second method for acquiring a signal of flicker detection by capturing an image using frame rates fewer than those of the first method;
driving the sensor by the first method before capturing a first still image for recording in continuous imaging, and performing first detection in the detecting the flicker based on the acquired signal;
driving the sensor by the second method in the controlling between capturing the first still image for recording and capturing a second still image for recording in the continuous imaging, and performing second detection in the detecting the flicker based on the acquired signal;
in a case where first flicker detected in the first detection is detected in the second detection, executing capturing of the second still image for recording; and
in a case where the first flicker is not detected in the second detection, driving the sensor in the controlling using a method different from the second method after the second detection, performing third detection in the detecting the flicker based on the acquired signal, and then executing capturing of the second still image for recording.

12. The non-transitory computer-readable storage medium according to claim 11, wherein the first method controls the sensor at n different frame rates, n being a natural number of three or more, and the least common multiple of the n frame rates does not include any of the n frame rates.

13. The non-transitory computer-readable storage medium according to claim 12, wherein the second method drives the sensor at one frame rate at which the first flicker can be detected.

14. The non-transitory computer-readable storage medium according to claim 13, wherein the second method drives the sensor at a first frame rate, which is one of the n different frame rates.

15. The non-transitory computer-readable storage medium according to claim 14, wherein a method for the sensor used in the third detection drives the sensor at frame rates excluding the first frame rate from the n different frame rates.
